(19) United States
(12) Patent Application Publication
(10) Pub. No.: US 2026/0031546 A1
(43) Pub. Date: Jan. 29, 2026

(54) DUAL POLARIZED ANTENNA AND ELECTRONIC DEVICE

(71) Applicant: Nanning FuLian FuGui Precision Industrial Co., Ltd., Nanning (CN)

(72) Inventors: YU-CHUAN CHEN, New Taipei (TW); CHIA-SHENG WEI, New Taipei (TW)

(21) Appl. No.: 18/780,549

(22) Filed: Jul. 23, 2024

(51) Int. Cl. H01Q 21/24; H01Q 21/00; H01Q 21/06

(52) U.S. Cl. CPC H01Q 21/24; H01Q 9/0435; H01Q 21/0075; H01Q 21/065

(57) ABSTRACT

A dual polarized antenna is arranged on a circuit board, including: M array antenna units arranged on a top layer of a circuit board; a first polarized feeding network arranged at a bottom of the circuit board, including a first feeding port and M first feeding network subunits; each first feeding network subunit corresponds to an array antenna unit, and each first feed network subunit is electrically connected to the corresponding array antenna unit through the first group of metal holes to excite the corresponding array antenna unit; a second polarized feed network arranged at the bottom, including a second feeding port and M second feeding network subunits, each second feeding network subunit corresponds to an array antenna unit, and each second feeding network subunit is electrically connected to the corresponding array antenna unit through a second group of metal holes to excite the corresponding array antenna unit.

### FIELD

The present disclosure generally relates to a technical field of antenna, and more particularly to a dual polarized antenna and electronic device.

### BACKGROUND

A dual polarization array antenna can simultaneously receive or transmit signals with two polarization modes perpendicular to each other, without interfering with each other, reducing the number of antennas and saving space occupied by antennas. However, traditional array antennas can only be designed as single polarization due to the limitation of PCB layout. If there is a need for dual polarization, another set of array antennas is needed, which increases the size of the product and cannot meet the miniaturization requirements. Additionally, adding a set of array antennas also leads to an increase in product cost.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a schematic diagram of the structure of a dual polarized antenna according to an embodiment of the present disclosure.

FIG. 2 is a schematic diagram of a stacked structure of a dual polarized antenna according to an embodiment of the present disclosure.

FIG. 3 is a schematic diagram of a structure of the first feeding network subunit and the second feeding network subunit of the dual polarized antenna according to an embodiment of the present disclosure.

FIG. 4 is a schematic diagram of a structure of the first polarized feeding network of the dual polarization antenna according to an embodiment of the present disclosure.

FIG. 5 is a schematic diagram of S-parameter curves of one antenna unit of the dual polarized antenna according to an embodiment of the present disclosure.

FIG. 6 is a schematic diagram of S-parameter curves of one array antenna unit of the dual polarized antenna according to an embodiment of the present disclosure.

FIG. 7 is a schematic diagram of S-parameter curves of the dual polarized antenna according to an embodiment of the present disclosure.

FIG. 8 is a pattern diagram of the first polarization pattern of the dual polarization antenna in an X-Z plane according to an embodiment of the present disclosure.

FIG. 9 is a pattern diagram of the first polarization pattern of the dual polarization antenna in a Y-Z plane according to an embodiment of the present disclosure.

FIG. 10 is a pattern diagram of the second polarization pattern of the dual polarization antenna in an X-Z plane according to an embodiment of the present disclosure.

FIG. 11 is a pattern diagram of the second polarization pattern of the dual polarization antenna in a Y-Z plane according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

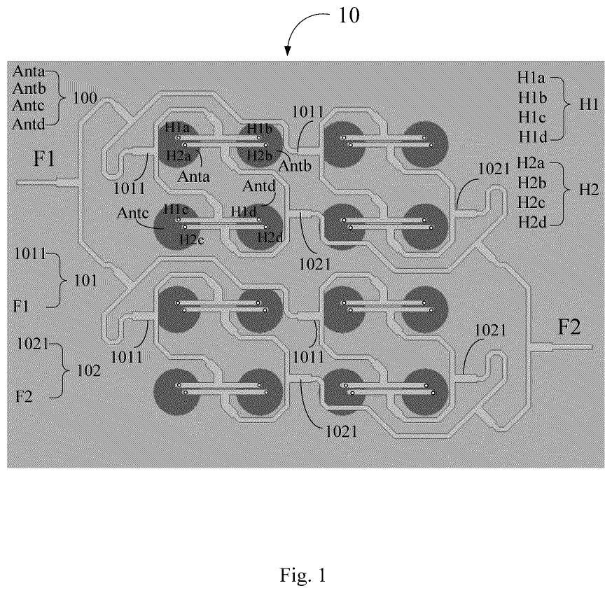

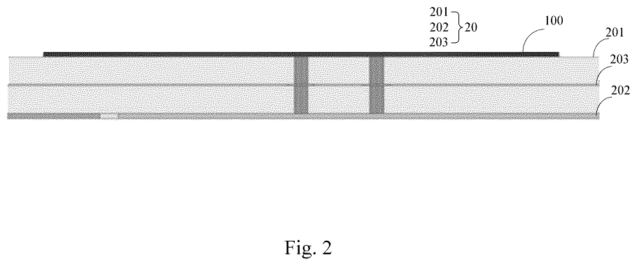

Referring to FIG. 1-FIG. 2, FIG. 1 is a schematic diagram of the structure of a dual polarized antenna according to an embodiment of the present disclosure. FIG. 2 is a schematic diagram of a stacked structure of a dual polarized antenna according to an embodiment of the present disclosure. In the embodiment, a dual polarized antenna 10 is mainly used in electronic devices, such as satellite communication products, base stations, etc. As shown in FIG. 2, the dual polarized antenna 10 is installed on a circuit board 20. The circuit board 20 includes a top layer 201, a bottom layer 202, and a middle layer 203, and the middle layer is a grounding layer. As shown in FIG. 1, the dual polarized antenna 10 includes M array antenna units 100, a first polarized feeding network 101, and a second polarized feeding network 102. M array antenna units 100 are arranged on the top layer 201 of the circuit board 20, wherein M is an integer greater than or equal to 1. Each array antenna unit 100 includes 4 antenna units Anta-Antd, that is, the dual polarization antenna 10 is an M*4 array antenna. Each antenna unit is preferably a circular patch antenna, and the four antenna units are located at four corners of a square. In order to better explain the present disclosure, in the embodiment, taking the 4*4 array antenna unit as an example, but not limited to this.

The first polarized feeding network 101 is arranged on the bottom layer 202 of the circuit board 20. The first polarized feeding network 101 includes a first feeding port F1 and four first feeding network subunits 1011. The four first feeding network subunits 1011 are connected through T-junctions. The first polarized feeding network 101 is configured to divide a feeding signal of the first feeding port F1 into 16 equal sub-signals.

Each first feeding network subunit 1011 corresponds to an array antenna unit 100. Each first feeding network subunit 1011 is electrically connected to the corresponding array antenna unit 100 through a first group of metal holes H1 (H1a-H1d). Each first feeding network subunit 1011 excites the corresponding array antenna unit through the first group of metal holes H1 to form a first polarization pattern.

The second polarized feeding network 102 is arranged on the bottom layer 202 of the circuit board 20. The second polarized feeding network 102 includes a second feeding port F2 and four second feeding network subunits 1021. The four second feeding network subunits 1021 are connected through T-junctions. The second polarized feeding network 102 is configured to divide a feeding signal of the second feeding port F2 into 16 equal sub-signals. Each second feeding network subunit 1021 corresponds to an array antenna unit 100. Each second feeding network subunit 1021 is electrically connected to the corresponding array antenna unit 100 through a second group of metal holes H2. Each second feeding network subunit 1021 excites the corresponding array antenna unit 100 through the second group of metal holes H2 (H2a-H2d) to form a second polarization pattern.

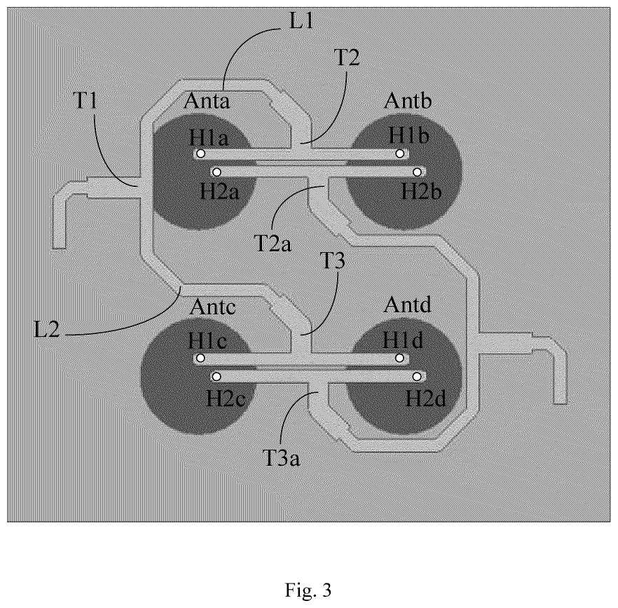

Specifically, combined with FIG. 3, FIG. 3 is a schematic diagram of a structure of the first feeding network subunit and the second feeding network subunit of the dual polarized antenna according to an embodiment of the present disclosure. As shown in the FIG. 3, each first feeding network subunit 1011 includes a first T-junction T1, a second T-junction T2, and a third T-junction T3. The first T-junction T1 includes an input end, a first output end, and a second output end. The first T-junction T1 is configured to divide the input signal of the first T-junction into two equal sub-signals. The second T-junction T2 includes an input end, a first output end and a second output end. The input end of the second T-junction T2 is electrically connected to the first output end of the first T-junction T1 through a first microstrip line L1. The second T-junction T2 is configured to divide an output signal of the first output end of the first T-junction T1 into two equal sub-signals. The third T-junction T3 includes an input end, a first output end, and a second output end. The input end of the third T-junction T3 is electrically connected to the second output end of the first T-junction T1 through a second microstrip line L2. The third T-junction T3 is configured to divide an output signal of the second output end of the first T-junction T1 into two equal sub-signals. A length of the first microstrip line L1 is equal to a length of the second microstrip line L2. The first output end and the second output end of the second T-junction T2 and the first output end and the second output end of the third T-junction T3 are respectively electrically connected to the four antenna units Ant of the array antenna unit 100 through metal holes. According to FIG. 2, the first output end and second output end of the second T-junction T2 of the first feeding network subunit 1011 are respectively electrically connected to the antenna units Anta and Antb through metal holes H1a and H1b. The first output end and second output end of the third T-junction T3 of the first feeding network subunit 1011 are respectively electrically connected to the antenna units Antc and Antd through metal holes H1c and H1d. A structure of the second feeding network subunit 1021 is the same as that of the first feeding network subunit 1011, and will not be repeated here. As shown in the FIG. 2, the first output end and the second output end of the second T-junction T2a of the second feeding network subunit 1021 are respectively electrically connected to the antenna units Anta and Antb through metal holes H2a and H2b. The first output end and the second output end of the third T-junction T3a of the second feeding network subunit 1021 are respectively electrically connected to the antenna units Antc and Antd through metal holes H2c and H2d.

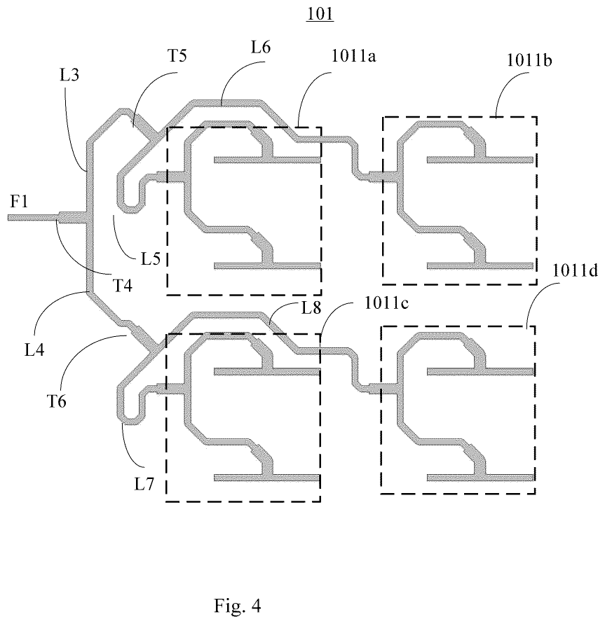

Combined with FIG. 4, FIG. 4 is a schematic diagram of a structure of the first polarized feeding network of the dual polarization antenna according to an embodiment of the present disclosure. The first polarized feeding network 101 includes the first feeding port F1, a third feeding network subunit 1011a, a fourth feeding network subunit 1011b, a fifth feeding network subunit 1011c, a sixth network feeding network subunit 1011d, a fourth T-junction T4, a fifth T-junction T5, and a sixth T-junction T6. The fourth T-junction T4 includes an input end, a first output end, and a second output end. The input end of the fourth T-junction T4 is electrically connected to the first input end F1. The fourth T-junction T4 is configured to divide the signal of the first input end F1 into two equal sub-signals. The fifth T-junction T5 includes an input end, a first output end, and a second output end. The input end of the fifth T-junction T5 is electrically connected to the first output end of the fourth T-junction T4 through a third microstrip line L3, the first output end of the fifth T-junction T5 is electrically connected to the first feeding network subunit 1011a through a fifth microstrip line L5, and the second output end of the fifth T-junction T5 is electrically connected to the second feeding network subunit 1011b through a sixth microstrip line L6. The sixth T-junction T6 includes an input end, a first output end, and a second output end. The input end of the sixth T-junction T6 is electrically connected to the second output end of the fourth T-junction T4 through a fourth microstrip line L4, the first output end of the sixth T-junction T6 is electrically connected to the third feeding network subunit 1011c through a seventh microstrip line L7, and the second output end of the sixth T-junction T6 is electrically connected to the fourth feeding network subunit 1011d through an eighth microstrip line L8. The first polarized feeding network 101 divides the feeding signal of the first feeding port F1 into 16 equal sub-signals. The length of the third microstrip line L3 is the same as the length of the fourth microstrip line L4. Due to the unequal length of the fifth microstrip line L5 and the sixth microstrip line L6, the length of the sixth microstrip line L6 is one wavelength longer than that of the fifth microstrip line L5, so that the phase of the signal entering the first feed network subunit 1011a is equal to the phase of the signal entering the second feed network subunit 1011b. Similarly, the length of the eighth microstrip line L8 is one wavelength longer than the length of the seventh microstrip line L7.

In the embodiment, the structure of the second polarized feeding network 102 is the same as that of the first polarized feeding network 101, which is not detailed here.

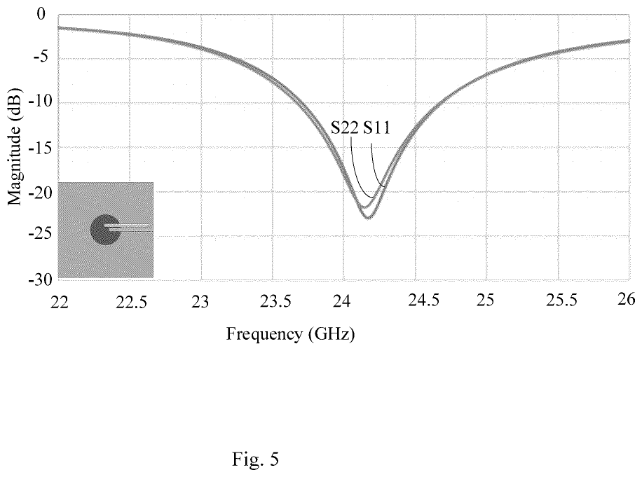

Referring to FIG. 5, FIG. 5 is a schematic diagram of S-parameter curves of one antenna unit of the dual polarized antenna according to an embodiment of the present disclosure. According to S11 and S22 parameter curves, the operating bandwidth of the antenna unit covers the 24 GHz frequency band, and the return loss is below −10 dB.

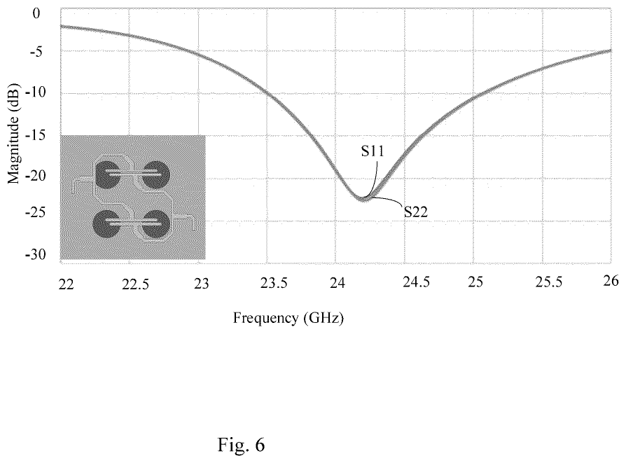

Referring to FIG. 6, FIG. 6 is a schematic diagram of S-parameter curves of one array antenna unit of the dual polarized antenna according to an embodiment of the present disclosure. According to S11 and S22 parameter curves, the operating bandwidth of the array antenna unit covers the 24 GHz frequency band, and the return loss is below −10 dB.

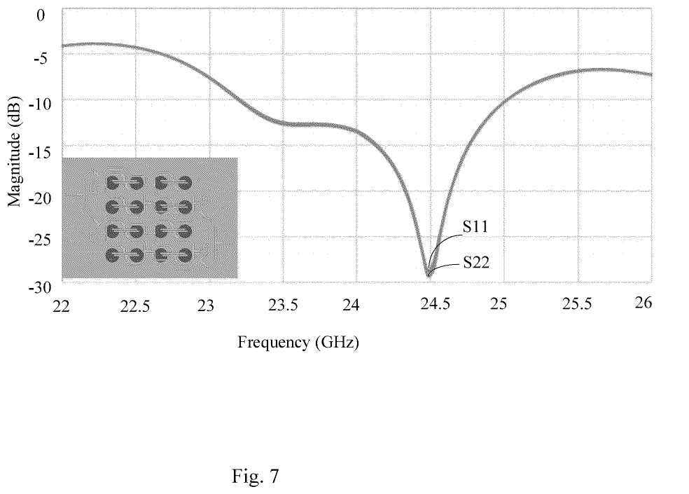

Referring to FIG. 7, FIG. 7 is a schematic diagram of S-parameter curves of the dual polarized antenna according to an embodiment of the present disclosure. According to S11 and S22 parameter curves, the operating bandwidth of the dual polarized antenna covers the 24 GHz frequency band, and the return loss is below −10 dB.

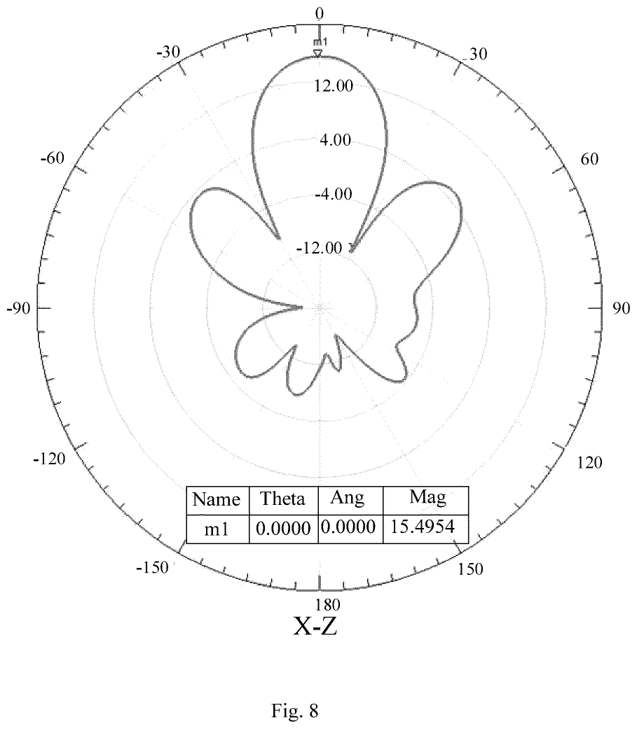

Referring to FIG. 8, FIG. 8 is a pattern diagram of the first polarization pattern of the dual polarization antenna in an X-Z plane according to an embodiment of the present disclosure. As shown in the FIG. 8, the first polarization pattern has the characteristics of high directivity and high gain, meeting the performance requirements of the array antenna.

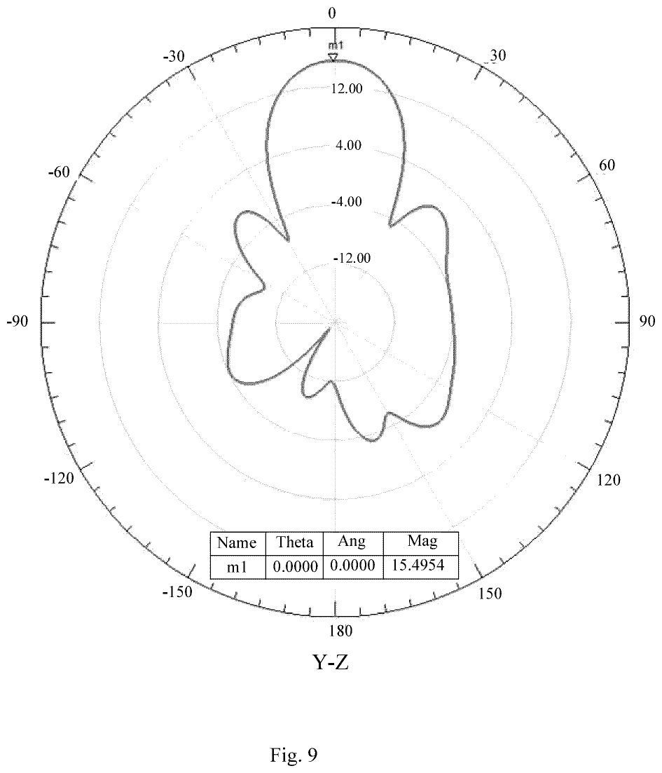

Referring to FIG. 9, FIG. 9 is a pattern diagram of the first polarization pattern of the dual polarization antenna in a Y-Z plane according to an embodiment of the present disclosure. As shown in the FIG. 9, the first polarization pattern has the characteristics of high directivity and high gain, meeting the performance requirements of the array antenna.

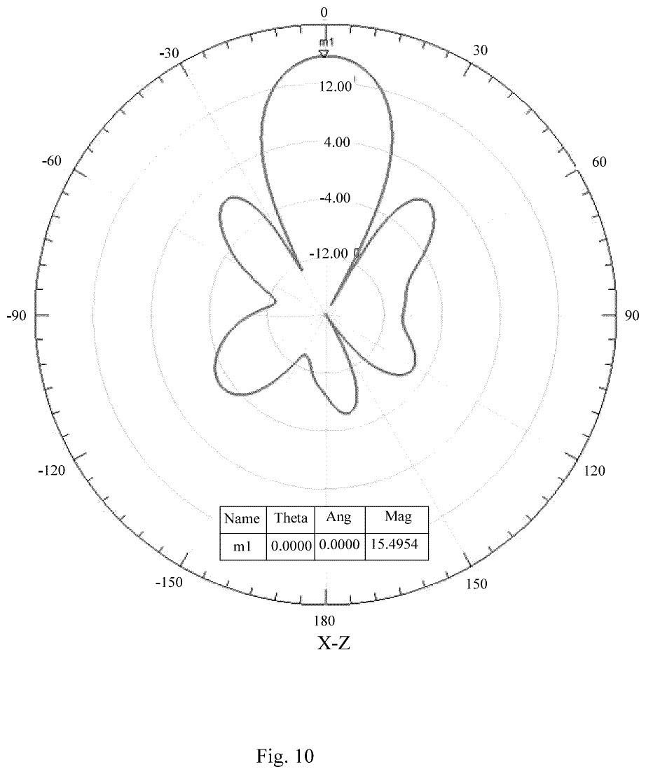

Referring to FIG. 10, FIG. 10 is a pattern diagram of the second polarization pattern of the dual polarization antenna in an X-Z plane according to an embodiment of the present disclosure. As shown in the FIG. 10, the second polarization pattern has the characteristics of high directivity and high gain, meeting the performance requirements of the array antenna.

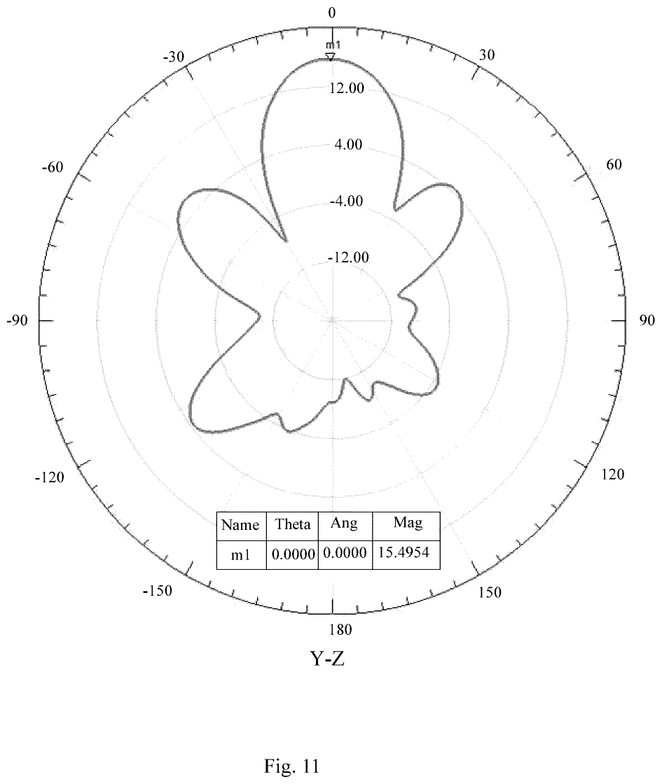

Referring to FIG. 11, FIG. 11 is a pattern diagram of the second polarization pattern of the dual polarization antenna in a Y-Z plane according to an embodiment of the present disclosure. As shown in the FIG. 11, the second polarization pattern has the characteristics of high directivity and high gain, meeting the performance requirements of the array antenna.

Compared to the prior art, the dual polarization antenna and electronic device provided by the present disclosure includes M array antenna units, a first polarized feeding network, and a second polarized feeding network. M array antenna units are arranged on the top layer of the circuit board, and the first polarized feeding network and the second polarized feeding network are arranged on the bottom layer of the circuit board. The first polarized feeding network and the second polarized feeding network excite the array antenna units of the top layer through metal holes to generate the first polarization pattern and the second polarization pattern, without adding another group array antennas to achieve dual polarization and reduce product volume, meeting the demand for product miniaturization. Further, the first polarized feeding network and the second polarized feeding network are arranged on the same layer, and the dual polarized feeding network is single-layer layout design, which reduces the number of layers of the circuit board and reduces the production cost.

Many details are often found in the relevant art and many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A dual polarized antenna arranged on a circuit board, the circuit board comprising a top layer, a bottom layer, and a middle layer, the middle layer being a ground layer, and the dual polarized antenna comprising:
M array antenna units, arranged on the top layer of the circuit board, wherein Mis an integer greater than or equal to 1, and each array antenna unit comprises four antenna units;
a first polarized feeding network, arranged on the bottom layer of the circuit board, wherein the first polarized feeding network comprises a first feeding port and M first feeding network subunits, and the first polarized feeding network is configured to divide a feeding signal of the first feeding port into M*4 equal sub-signals, each first feeding network subunit corresponds to one array antenna unit, the each first feeding network subunit is electrically connected to a corresponding array antenna unit through a first group of metal holes, and the each first feeding network subunit excites the corresponding array antenna unit through the first group of metal holes;
a second polarized feeding network, arranged on the bottom layer of the circuit board, wherein the second polarized feeding network comprises a second feeding port and M second feeding network subunits, and the second polarized feeding network is configured to divide a feeding signal of the second feeding port into M*4 equal sub-signals, each second feeding network subunit corresponds to one array antenna unit, the each second feeding network subunit is electrically connected to the corresponding array antenna unit through a second group of metal holes, and the each second feeding network subunit excites the corresponding array antenna unit through the second group of metal holes.

2. The dual polarized antenna according to claim 1, wherein the each first polarized feeding network comprises:
a first T-junction, comprising an input end, a first output end and a second output end, wherein the first T-junction is configured to divide a signal of the input end of the first T-junction into two equal sub-signals;
a second T-junction, comprising an input end, wherein the input end of the second T-junction is electrically connected to the first output end of the first T-junction through a first microstrip line, thereby dividing an output signal of the first output end of the first T-junction into two equal sub-signals;
a third T-junction, comprising an input end, wherein the input end of the third T-junction is electrically connected to the second output end of the first T-junction through a second microstrip line, and the third T-junction is configured to divide an output signal of the second output end of the first T-junction into two equal sub-signals.

3. The dual polarized antenna according to claim 2, wherein a first output end of the second T-junction, a second output end of the second T-junction, a first output end of the third T-junction and a second output end of the third T-junction are respectively electrically connected to four antenna units of the M array antenna units through metal holes.

4. The dual polarized antenna according to claim 2, wherein a length of the first microstrip line is equal to a length of the second microstrip line.

5. The dual polarized antenna according to claim 1, wherein a structure of the first feeding network subunit is same as a structure of the second feeding network subunit.

6. The dual polarized antenna according to claim 1, wherein each of the four antenna units is a circular patch antenna.

7. The dual polarized antenna according to claim 2, wherein:
the M array antenna units are 4*4 array antenna units;
the first polarized feeding network comprises the first feeding port, a third feeding network subunit, a fourth feeding network subunit, a fifth feeding network subunit, a sixth network feeding network subunit, and further comprises:
a fourth T-junction comprising an input end, a first output end and a second output end, wherein the input end of the fourth T-junction is electrically connected to the first feeding port, and the fourth T-junction is configured to divide the signal of the first feeding port into two equal sub-signals;
a fifth T-junction comprising an input end, a first output end and a second output end, wherein the input end of the fifth T-junction is electrically connected to the first output end of the fourth T-junction through a third microstrip line, the first output end of the fifth T-junction is electrically connected to the third feeding network subunit through a fifth microstrip line, and the second output end of the fifth T-junction is electrically connected to the fourth feeding network subunit through a sixth microstrip line;
a sixth T-junction, comprising an input end, a first output end, and a second output end, the input end of the sixth T-junction is electrically connected to the second output end of the fourth T-junction through a fourth microstrip line, the first output end of the sixth T-junction is electrically connected to the fifth feeding network subunit through a seventh microstrip line, and the second output end of the sixth T-junction is electrically connected to the sixth feeding network subunit through an eighth microstrip line.

8. The dual polarized antenna according to claim 7, wherein:
a length of the sixth microstrip line is one wavelength longer than a length of the fifth microstrip line;
a length of the eighth microstrip line is one wavelength longer than a length of the seventh microstrip line.

9. The dual polarized antenna according to claim 8, wherein a structure of the first polarized feeding network is same as a structure of the second polarized feeding network.

10. An electronic device, comprising a dual polarized antenna, wherein the dual polarized antenna is arranged on a circuit board, the circuit board comprises a top layer, a bottom layer, and a middle layer, the middle layer is a ground layer, and the dual polarized antenna comprises:
M array antenna units, arranged on the top layer of the circuit board, wherein Mis an integer greater than or equal to 1; and each array antenna unit comprises four antenna units;
a first polarized feeding network, arranged on the bottom layer of the circuit board, wherein the first polarized feeding network comprises a first feeding port and M first feeding network subunits, and the first polarized feeding network is configured to divide a feeding signal of the first feeding port into M*4 equal sub-signals; each first feeding network subunit corresponds to one array antenna unit, the each first feeding network subunit is electrically connected to a corresponding array antenna unit through a first group of metal holes; and the each first feeding network subunit excites the corresponding array antenna unit through the first group of metal holes;
a second polarized feeding network, arranged on the bottom layer of the circuit board, wherein the second polarized feeding network comprises a second feeding port and M second feeding network subunits, and the second polarized feeding network is configured to divide a feeding signal of the second feeding port into M*4 equal sub-signals; each second feeding network subunit corresponds to one array antenna unit, the each second feeding network subunit is electrically connected to the corresponding array antenna unit through a second group of metal holes; and the each second feeding network subunit excites the corresponding array antenna unit through the second group of metal holes.

11. The electronic device according to claim 10, wherein the each first polarized feeding network comprises:
a first T-junction, comprising an input end, a first output end and a second output end, wherein the first T-junction is configured to divide a signal of the input end of the first T-junction into two equal sub-signals;
a second T-junction, comprising an input end, wherein the input end of the second T-junction is electrically connected to the first output end of the first T-junction through a first microstrip line, thereby dividing an output signal of the first output end of the first T-junction into two equal sub-signals;
a third T-junction, comprising an input end, wherein the input end of the third T-junction is electrically connected to the second output end of the first T-junction through a second microstrip line, and the third T-junction is configured to divide an output signal of the second output end of the first T-junction into two equal sub-signals.

12. The electronic device according to claim 11, wherein a first output end of the second T-junction, a second output end of the second T-junction, a first output end of the third T-junction and a second output end of the third T-junction are respectively electrically connected to four antenna units of the M array antenna units through metal holes.

13. The electronic device according to claim 11, wherein a length of the first microstrip line is equal to a length of the second microstrip line.

14. The electronic device according to claim 10, wherein a structure of the first feeding network subunit is same as a structure of the second feeding network subunit.

15. The electronic device according to claim 10, wherein each of the four antenna units is a circular patch antenna.

16. The electronic device according to claim 11, wherein:
the M array antenna units are 4*4 array antenna units;
the first polarized feeding network comprises the first feeding port, a third feeding network subunit, a fourth feeding network subunit, a fifth feeding network subunit, a sixth network feeding network subunit, and further comprises:
a fourth T-junction comprising an input end, a first output end and a second output end, wherein the input end of the fourth T-junction is electrically connected to the first feeding port, and the fourth T-junction is configured to divide the signal of the first feeding port into two equal sub-signals;
a fifth T-junction comprising an input end, a first output end and a second output end, wherein the input end of the fifth T-junction is electrically connected to the first output end of the fourth T-junction through a third microstrip line, the first output end of the fifth T-junction is electrically connected to the third feeding network subunit through a fifth microstrip line, and the second output end of the fifth T-junction is electrically connected to the fourth feeding network subunit through a sixth microstrip line;
a sixth T-junction comprising an input end, a first output end, and a second output end, the input end of the sixth T-junction is electrically connected to the second output end of the fourth T-junction through a fourth microstrip line, the first output end of the sixth T-junction is electrically connected to the fifth feeding network subunit through a seventh microstrip line, and the second output end of the sixth T-junction is electrically connected to the sixth feeding network subunit through an eighth microstrip line.

17. The electronic device according to claim 16, wherein:
a length of the sixth microstrip line is one wavelength longer than a length of the fifth microstrip line;
a length of the eighth microstrip line is one wavelength longer than a length of the seventh microstrip line.

18. The electronic device according to claim 17, wherein a structure of the first polarized feeding network is same as a structure of the second polarized feeding network.
